(19) United States
(12) Patent Application Publication
(10) Pub. No.: US 2021/0158793 A1
(43) Pub. Date: May 27, 2021

(54) ELECTRONIC APPARATUS AND CONTROLLER

(71) Applicant: SHARP KABUSHIKI KAISHA, Sakai City (JP)

(72) Inventor: YUANYE LIU, Sakai City (JP)

(21) Appl. No.: 17/100,545

(22) Filed: Nov. 20, 2020

(30) Foreign Application Priority Data
Nov. 26, 2019 (JP) 2019-213310

(51) Int. Cl. G10K 11/18; H04M 11/00

(52) U.S. Cl. CPC G10K 11/18; H04M 11/00

(57) ABSTRACT

An electronic apparatus includes at least one sound output unit, a plurality of sensors, and at least one controller. The at least one controller performs a process of determining the status of use of the electronic apparatus in accordance with detected values acquired from the individual sensors. The at least one controller also performs a process of, upon determining that the electronic apparatus is under a status of use where an output sound emitted from the at least one sound output unit needs to undergo sound level limitation, limiting the sound level of the output sound when an event accompanied by audio output occurs in the electronic apparatus.

### CROSS-REFERENCE TO RELATED APPLICATION

The present application claims priority from Japanese Application JP2019-213310, the content of which is hereby incorporated by reference into this application.

### BACKGROUND OF THE INVENTION

### Field of the Invention

The present invention relates to an electronic apparatus that outputs a sound.

### Description of the Background Art

Push notification is commonly available on a conventional electronic apparatus, such as a smartphone. Push notification is a user notification function of an electronic apparatus, in which the electronic apparatus notifies a particular event that occurs in the electronic apparatus by sounding voluntarily without user operation. Push notification allows a user to get various pieces of information in real time.

Such an electronic apparatus that sounds voluntarily regardless of user operation needs to be designed in such a manner that the user is not physically and mentally damaged by a loud sound that is output at his/her unintentional timing.

For instance, Japanese Patent Application Laid-Open No. 2009-130419 describes an electronic apparatus that includes a communication-state determining means for determining whether the apparatus is in the process of handling a telephone conversation at the time of sounding an alarm, such as an earthquake early warning. The electronic apparatus also includes a means for sound level regulation that sets an upper limit to a sound level in a sound output unit of the apparatus upon determining, in the communication-state determining means, that the apparatus is in the process of handling a telephone conversation at the time of receiving an earthquake early warning or other alarms.

### SUMMARY OF THE INVENTION

This conventional technique unfortunately has some problems. One of the problems is that such an electronic apparatus (e.g., smartphone) having various functions can output a loud sound that could harm the user's sense of hearing or the user's body and mind, not only at the time of sounding an alarm, such as an earthquake early waning, but also at the time of the occurrence of other events. This electronic apparatus needs to protect the user's sense of hearing or the user's body and mind from a loud sound, not only during a user's telephone conversation, but also during any other use. For instance, sounding a loud ringtone can surprise an infant or toddler who is using the electronic apparatus as a plaything, or can adversely affect his/her ears. Likewise, sounding a relatively loud tone in push notification can surprise a user who is using an application (e.g., a music playback application) that is viewed and listened to for pleasure, or can adversely affect his/her ears.

It is an object of one aspect of the present invention to provide an electronic apparatus that protects the user's sense of hearing or the user's body and mind from a loud sound that can occur in the electronic apparatus in various kinds of use.

One aspect of the present invention is directed to an electronic apparatus that includes at least one sound output unit, a plurality of sensors, and at least one controller. The at least one controller performs a process of determining the status of use of the electronic apparatus in accordance with detected values acquired from the individual sensors. The at least one controller also performs a process of, upon determining that the electronic apparatus is under a status of use where an output sound emitted from the at least one sound output unit needs to undergo sound level limitation, limiting the sound level of the output sound when an event accompanied by audio output occurs in the electronic apparatus.

Another aspect of the present invention is directed to a controller that controls an electronic apparatus that includes at least one sound output unit and a plurality of sensors. The controller includes a determination unit that determines the status of use of the electronic apparatus in accordance with detected values acquired from the individual sensors. The controller also includes a sound output controller that, upon determination that the electronic apparatus is under a status of use where an output sound emitted from the at least one sound output unit needs to undergo sound level limitation, limits the sound level of the output sound when an event accompanied by audio output occurs in the electronic apparatus.

Still another aspect of the present invention is directed to a method for controlling an electronic apparatus that includes at least one sound output unit, a plurality of sensors, and at least one controller. The method includes determining the status of use of the electronic apparatus in accordance with detected values acquired from the individual sensors. Herein, the determining step is performed by the at least one controller. The method also includes, upon determining that the electronic apparatus is under a status of use where an output sound emitted from the at least one sound output unit needs to undergo sound level limitation, limiting the sound level of the output sound when an event accompanied by audio output occurs in the electronic apparatus. Herein, the limiting step is performed by the at least one controller.

These aspects of the present invention enable the electronic apparatus to protect the user's sense of hearing or the user's body and mind from a loud sound that can occur in the electronic apparatus in various kinds of use.

### BRIEF DESCRIPTION OF THE DRAWINGS

FIG. 1 is a block diagram illustrating the configuration of main components of an electronic apparatus;

FIG. 2 illustrates an example data structure of a rule table;

FIG. 3 is a flowchart illustrating a process of how a controller of the electronic apparatus protects the sense of hearing; and

FIG. 4 is a flowchart illustrating, in detail, a process of determining the status of use, which is included in the process of protecting the sense of hearing.

### DETAILED DESCRIPTION OF THE INVENTION

### First Preferred Embodiment

Hardware Configuration

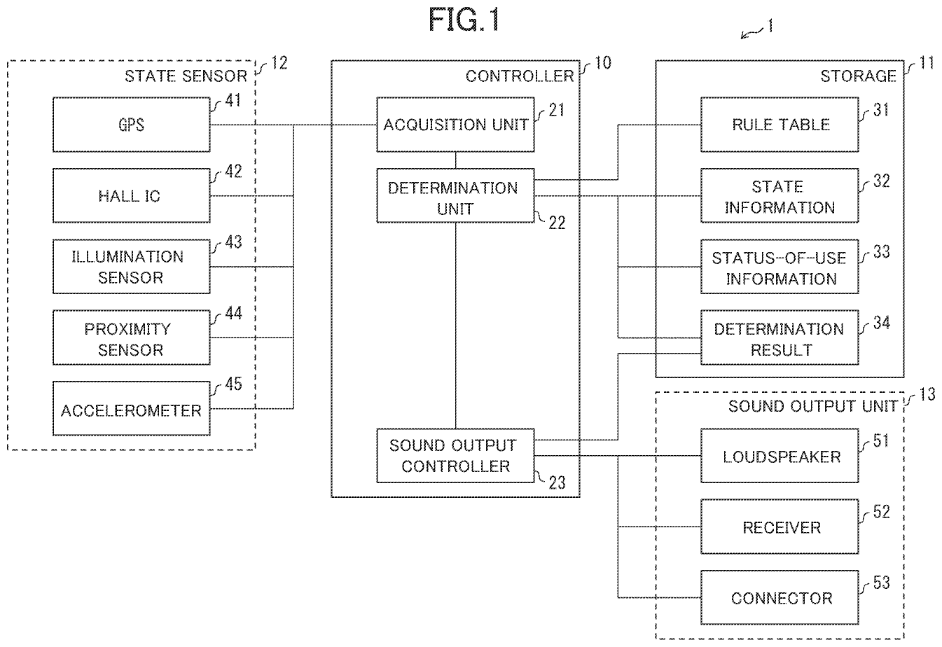

FIG. 1 is a block diagram illustrating the configuration of main components of an electronic apparatus according to a first preferred embodiment. The electronic apparatus in this disclosure is a smartphone by way of example only. A smartphone 1 (i.e., electronic apparatus) includes, by way of example only, a controller 10, a storage 11, a state sensor 12 (i.e., sensor), and a sound output unit 13. To achieve functions provided in typical smartphones, the smartphone 1 may further include various components (not shown) that are included in these smartphones as standard.

The state sensors 12 detects information necessary for determining the state of the smartphone 1. For instance, the state sensor 12 detects physical quantity measured in the main body of the smartphone 1 or in an environment around the smartphone 1, and transmits the detected value to the controller 10.

The smartphone 1 may include multiple state sensors 12. The smartphone 1 according to this preferred embodiment includes, by way of example only, a global positioning system (GPS) 41, a Hall integrated circuit (IC) 42, an illumination sensor 43, a proximity sensor 44, and an accelerometer 45, all of which are the state sensors 12.

The GPS 41 receives a signal from a GPS satellite to acquire positional information indicating the current position of the smartphone 1. The signal received by the GPS 41 is processed by the controller 10 as positional information of the smartphone 1. The positional information is herein information including, but not limited to, latitude, longitude, and altitude.

The Hall IC 42 is a magnetic sensor that uses the Hall effect. The Hall IC 42 outputs a value of voltage that occurs in directions perpendicular to the direction of current and to the direction of magnetic field when a thin semiconductor film receives a current and is applied with a magnetic field perpendicular to its surface. The voltage value is processed by the controller 10 as information indicating the opening/closing of the cover of the smartphone 1.

The illumination sensor 43 measures the illumination of light observed around the smartphone 1. The illumination sensor 43 outputs the measured illumination value to the controller 10.

The proximity sensor 44 detects the proximity of an object to the case or touch panel (not shown) of the smartphone 1. The proximity detected by the proximity sensor 44 may include contact between the object and the smartphone 1. The proximity sensor 44 outputs an ON/OFF signal indicating the proximity or distantness of the object to the controller 10. It is noted that the proximity sensor 44 may be any kind of sensor that can detect the proximity of the object. For instance, the proximity sensor 44 may be an infrared proximity sensor or an optical proximity sensor.

The accelerometer 45 detects acceleration that acts on the smartphone 1. The accelerometer 45 outputs the measured acceleration value to the controller 10. This acceleration value is processed by the controller 10 as information indicating whether the smartphone 1 is in motion.

The smartphone 1 may further include, but not limited to, a gyroscope that detects the attitude of the smartphone 1 as the state sensor 12.

The sound output unit 13 outputs an audio signal processed by and transmitted from the controller 10 through, as necessary, digital-to-analog conversion and amplification so that a user can hear the audio signal as a sound. The smartphone 1 may include multiple sound output units 13. By way of example only, the smartphone 1 according to this preferred embodiment includes a loudspeaker 51 and a receiver 52 as the sound output units 13.

The loudspeaker 51 outputs a sound based on the audio signal transmitted by the controller 10, from a loudspeaker hole (not shown) disposed in any location of the smartphone 1. For instance, the loudspeaker 51 outputs the sound at a sound level that is enough for the use to hear the sound with his/her ears distant from the smartphone 1. The loudspeaker 51 outputs sounds, such as a ringtone, a notification sound, a music sound in playback, and a sound of a moving image.

The receiver 52 outputs a sound based on the audio signal transmitted by the controller 10, from a receive hole (not shown). For instance, the receiver hole is preferably disposed in a place where the receiver hole naturally touches the user's ear when the user brings his/her holding smartphone 1 close to the ear. For instance, the receiver 52 outputs the sound at a sound level lower than the sound level of the sound from the loudspeaker hole. To be specific, the receiver 52 outputs the sound at a sound level that is enough for the user to hear the sound with his/her ear close to the receiver hole. The receiver 52 outputs sounds, such as the voice of a person on the other end of the line, a notification sound, a music sound in playback, and a sound of a moving image.

The smartphone 1 may have, as the sound output unit 13, a connector 53 (or joint) for connecting an external sound output unit (e.g., earphones or a headset) to the smartphone 1. For instance, the connector 53 is an earphone jack for connecting the earphones. The external sound output unit (e.g., earphones) connected via the connector 53 functions as the sound output unit 13 and is controllable by the controller 10. The external sound output unit connected via the connector 53 outputs sounds, such as the voice of a person on the other end of the line, a notification sound, a music sound in playback, and a sound of a moving image.

The controller 10 controls the operation of each unit of the smartphone 1 centrally. The controller 10 consists of a computer device that includes a calculator, such as a central processing unit (CPU) or a dedicated processor. The controller 10 can control the operation of each unit of the smartphone 1 by reading and executing a program that is stored in the storage 11 and is used to control each unit of the smartphone 1. The controller 10 will be detailed later on.

The storage 11 stores various pieces of data that are used by the controller 10. Examples of the storage 11 include a random access memory and a read only memory (ROM). The storage 11 in this preferred embodiment stores, but not limited to, a rule table 31 in a non-volatile manner. The storage 11 in this preferred embodiment also stores state information 32, status-of-use information 33, and a determination result 34 in a volatile or non-volatile manner. The structure of these data pieces will be detailed later on.

Software Configuration

By way of example only, the controller 10 of the smartphone 1 at least includes an acquisition unit 21, a determination unit 22, and a sound output controller 23. The controller 10 serving as a central processing unit (CPU) or as other units reads a program stored in a memory (e.g., a read only memory or ROM for short) and writes the program into a random access memory (RAM) to execute the program, thus implementing these units.

The acquisition unit 21 of the controller 10 acquires signals from the individual state sensors 12. The acquisition unit 21 converts, as necessary, the acquired signals into pieces of digital data indicating the values measured by the individual state sensors 12. The acquisition unit 21 supplies the detected values after conversion into digital data to the determination unit 22.

The determination unit 22 identifies the current status of use of the smartphone 1 on the basis of the values detected by the individual state sensors 12 and supplied from the acquisition unit 21. The determination unit 22 then determines whether to impose sound level limitation on the smartphone 1 under the current status of use.

To be specific, the determination unit 22 first generates the state information 32, indicating the state of the smartphone 1, on the basis of the values detected by the individual state sensors 12.

The state information 32 indicates the state of the smartphone 1 identified based on the detected values acquired from the individual state sensors 12. The state of the smartphone 1 means, for instance, the state of the main body of the smartphone 1 and the state of an environment in which the smartphone 1 is placed.

By way of example only, the state information 32 in this preferred embodiment consists of a group of binary data pieces (hereinafter referred to as flag information) in which the state of the smartphone 1 indicated by the values detected by the individual state sensors 12 is expressed in binary form. The smartphone 1 according to this preferred embodiment includes five state sensors 12; accordingly, the state information 32 consists of five pieces of flag information corresponding to the respective detected values. To be more specific, the state information 32 consists of first to fifth items listed below. The first item is used for storing flag information based on the value detected by the GPS 41. The second item is used for storing flag information based on the value detected by the Hall IC 42. The third item is used for storing flag information based on the value detected by the illumination sensor 43. The fourth item is used for storing flag information based on the value detected by the proximity sensor 44. The fifth item is used for storing flag information based on the value detected by the accelerometer 45. When the positional information acquired from the GPS 41 changes moment to moment for instance, which means that the smartphone 1 is moving, the determination unit 22 sets a flag indicating that the smartphone 1 is moving. By way of example only, the determination unit 22 stores flag information expressed by “1” indicating that the smartphone 1 is moving, in the first item of the state information 32.

The determination unit 22 stores the generated state information 32 temporarily in the storage 11, and uses the state information 32 to determine the current status of use of the smartphone 1.

The determination unit 22 next identifies the status of use of the smartphone 1 on the basis of the generated state information 32, and generates the status-of-use information 33 indicating the current status of use of the smartphone 1. To be specific, the determination unit 22 refers to the rule table 31 that is stored in the storage 11 in advance, and identifies the status-of-use information 33 corresponding to the generated current state information 32.

The status-of-use information 33 indicates how the user is using the smartphone 1. The status-of-use information 33 in this preferred embodiment includes, but not limited to, information indicating whether the user is listening to a sound emitted from the smartphone 1. In this preferred embodiment, such use of the smartphone 1 is referred to as sound-listening use. The status-of-use information 33 further includes information indicating whether the smartphone 1 is being held near his/her head, that is, near his/her ear even though the smartphone 1 is not in sound-listening use. In this preferred embodiment, such holding of the smartphone 1 is referred to as near-head holding.

The status-of-use information 33 in this preferred embodiment accordingly indicates any of the following numerals: “2” representing a status where sound-listening use is in progress; “1” representing a status where not sound-listening use, but near-head holding is in progress; and “0” representing a status where neither sound-listening use nor near-head holding is in progress.

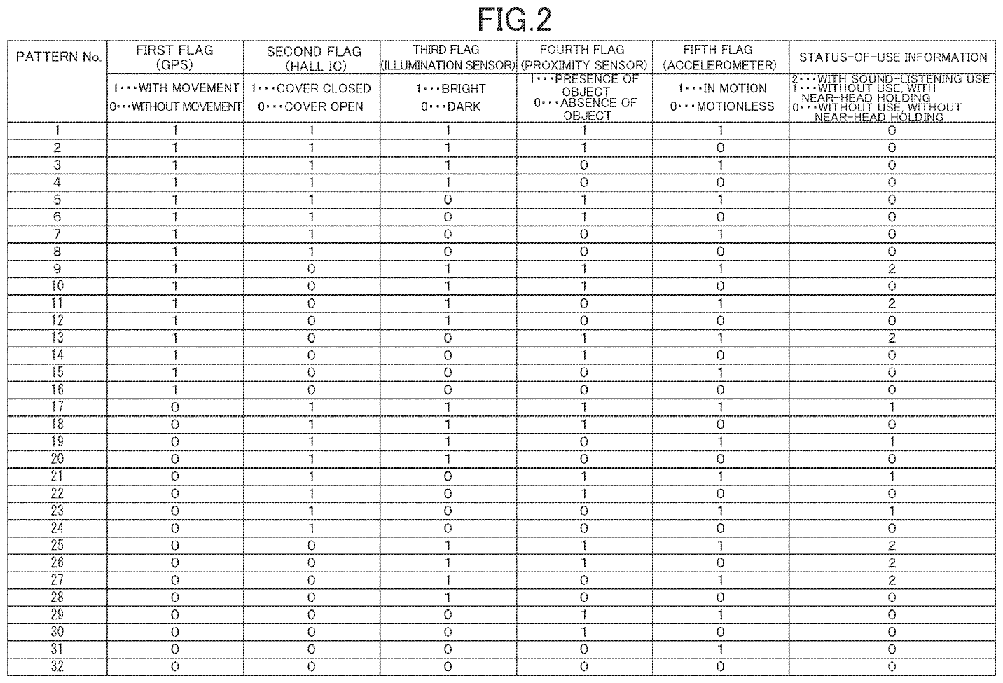

On the rule table 31, the status-of-use information 33 is associated for each of flag patterns of the first to fifth items. The determination unit 22 refers to the rule table 31 to identify the status-of-use information 33 corresponding to the generated state information 32. In this way, the determination unit 22 can identify how the smartphone 1 is currently being used. The determination unit 22 stores the identified status-of-use information 33 temporarily in the storage 11. The data structure of the rule table 31 will be detailed later on with reference to FIG. 2.

The determination unit 22 finally determines whether to, at the moment, impose sound level limitation on the smartphone 1. For the status-of-use information 33 indicating “2”, which means the presence of sound-listening use, the determination unit 22 determines that sound level limitation is necessary. Moreover, for the status-of-use information 33 indicating “1”, which means the presence of near-head holding, the determination unit 22 determines that sound level limitation is necessary. Moreover, for the status-of-use information 33 indicating “0”, which means the absence of sound-listening use and the absence of near-head holding, the determination unit 22 determines that sound level limitation is unnecessary. The determination unit 22 stores the determination result 34, i.e., information indicating whether to limit the sound level, in the storage 11.

When an event accompanied by audio output occurs in the smartphone 1, the sound output controller 23 controls the sound output unit 13 to output an audio signal generated by each unit (not shown) of the controller 10 as a sound. When such an event occurs, the sound output controller 23 in this preferred embodiment limits the sound level and outputs the sound in response to the determination result 34 indicating that sound limitation is necessary. Examples of the sound level limitation imposed by the sound output controller 23 include setting of an upper limit to the sound level of an output sound, and subtracting predetermined decibels from a normal level of output sound to emit a sound. The sound level limitation is not limited to the above example processes.

Rule Table

FIG. 2 illustrates an example data structure of the rule table 31. The rule table 31 is information indicating a rule that specifies how to determine the status of use of the smartphone 1 in which state the smartphone 1 is placed.

The rule table 31 in this preferred embodiment shows a definition of the correspondence between the state information 32 and status-of-use information 33 of the smartphone 1. The rule table 31 has the following items by way of example only: pattern number, first to fifth flags, and status-of-use information.

The rule on the rule table 31 in FIG. 2 is provided by way of example only. It is thus not intended that the rule for determination performed in the determination unit 22 of the controller 10 according to the present disclosure is limited to what is shown in FIG. 2. The rule table 31 can be designed as appropriate according, for instance, to a common method of use of an electronic apparatus to which the present invention is applied, to a common purpose of use of the electronic apparatus, to the number of state sensors 12, and to the type of the state sensor 12.

For the item pattern number, pattern numbers are stored that are pieces of identification information for uniquely identifying the state information 32, which differs for each pattern of the flag information. This item is provided for convenience in identifying the pattern of the flag information of the state information 32, and may be hence omitted as appropriate if unnecessary. Since the state information 32 in this preferred embodiment consists of five pieces of flag information, there are 2-to-the 5^{th}-power patterns (i.e., 32 patterns). The pattern numbers are provided in such a manner that 32 ways of the state information 32 can be uniquely identified.

In the item first flag, flag information is stored that is based on the value detected by the GPS 41. In the item second flag, flag information is stored that is based on the value detected by the Hall IC 42. In the item third flag, flag information is stored that is based on the value detected by the illumination sensor 43. In the item fourth flag, flag information is stored that is based on the value detected by the proximity sensor 44. In the item fifth flag, flag information is stored that is based on the value detected by the accelerometer 45.

In the item status-of-use information, the status-of-use information 33 is stored that corresponds to a pattern of the state information 32. As earlier described, the status-of-use information 33 indicates any one of the following: “0”, which means (the absence of sound-listening use) the absence of near-head holding: “1”, which means (the absence of sound-listening use) the presence of near-head holding; and “2”, which means the presence of sound-listening use.

Let the smartphone 1 be in the following situation: the smartphone 1 is moving, its cover is closed, the smartphone 1 is located in a bright place, an object is immediately adjacent to the smartphone 1, and the smartphone 1 is being operated. Accordingly, the determination unit 22 generates the state information 32 indicating a value “1, 1, 1, 1, 1”, representing the first to fifth items sequentially, as a piece of information indicating the current state of the smartphone 1. Such state information 32 falls under Pattern No. 1 on the rule table 31. The determination unit 22 thus determines “0” associated with the state information 32 in Pattern No. 1, as the current status-of-use information 33 of the smartphone 1. That is, the determination unit 22 can determine the status of use of the smartphone 1 as “the absence of sound-listening use and the absence of near-head holding” on the basis of the state information 32 of the pattern “1, 1, 1, 1, 1”.

Process Steps

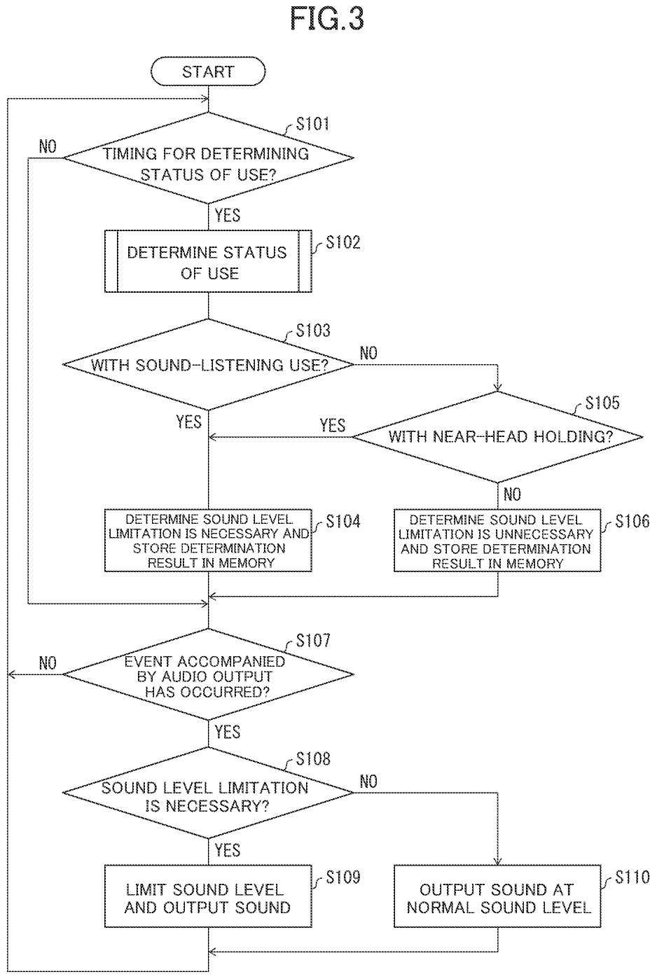

FIG. 3 is a flowchart illustrating a process of how the controller 10 of the smartphone 1 protects the sense of hearing. In this preferred embodiment, a process of status-of-use determination is executed, where the status of use of the smartphone 1 is determined periodically (for instance, every several seconds to several minutes) during the power-on of the smartphone 1. The detected values from the individual state sensors 12 are received via the acquisition unit 21 anytime during the power-on.

In Step S101, the determination unit 22 determines whether the timing of determining the status of use of the smartphone 1 has come. If the timing has come (i.e., if YES), the determination unit 22 proceeds from Step S101 to Step S102. If the timing has not yet come (i.e., if NO), the determination unit 22 proceeds from Step S101 to Step 107.

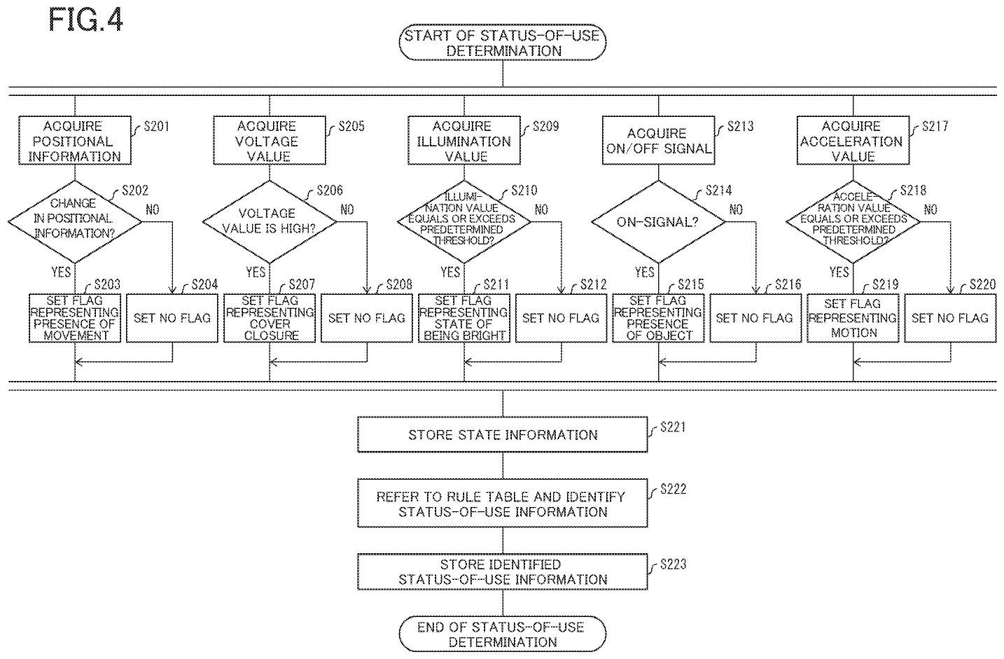

In Step S102 (i.e., a determination process, a determination step), the determination unit 22 determines the status of use. The determination unit 22 identifies the status-of-use information 33, indicating the current (i.e., the time point of Step S101) status of use of the smartphone 1, on the basis of values detected by the individual state sensors 12 and supplied from the acquisition unit 21. The determination unit 22 then stores the identified status-of-use information 33 in the storage 11. The details will be described later on with reference to FIG. 4.

In Steps S103 to S106, the determination unit 22 determines whether to impose sound level limitation on the smartphone 1 at the moment.

To be specific, the determination unit 22 proceeds from Step 103 (YES) to Step S104 in response to the status-of-use information 33 indicating “2”, the presence of sound-listening use. The determination unit 22 then determines in Step S104 that sound level limitation is necessary, and stores the determination result 34 indicating the necessity of sound level limitation in the storage 11.

The determination unit 22 proceeds from Step 103 (NO) to Step S105 and proceeds from Step S105 (YES) to Step 104, in response to the status-of-use information 33 indicating “1”, the absence of sound-listening use and the presence of near-head holding. The determination unit 22 then determines in Step S104 that sound level limitation is necessary, and stores the determination result 34 indicating the necessity of sound level limitation in the storage 11.

The determination unit 22 proceeds from Step S103 (NO) to Step 105 and proceeds from Step S105 (NO) to Step S106, in response to the status-of-use information 33 indicating “0”, the absence of sound-listening use and the absence of near-head holding. The determination unit 22 then determines in Step S106 that sound level limitation is unnecessary, and stores the determination result 34 indicating the unnecessity of sound level limitation in the storage 11.

In Step S107, the sound output controller 23 monitors whether an event accompanied by audio output occurs in the smartphone 1 during the power-on of the smartphone 1. The sound output controller 23 proceeds from Step S107 (YES) to Step S108 upon occurrence of such an event.

In Step S108, the sound output controller 23 reads the determination result 34 that is stored in the storage 11 at the time point of the event occurrence (i.e., the time point of Step S107). The sound output controller 23 then determines whether sound level limitation is necessary on the basis of the determination result 34. The sound output controller 23 proceeds from Step S108 (YES) to Step 109 in response to the determination result 34 indicating the necessity of sound level limitation. The sound output controller 23 proceeds from Step S108 (NO) to Step S110 in response to the determination result 34 indicating the unnecessity of sound level limitation.

In Step S109 (i.e., a process of sound level limitation, a step of sound level limitation), the sound output controller 23 controls the sound output unit 13 to output a sound at a limited sound level. For instance, the sound output controller 23 may control the sound output unit 13 to output a sound at a sound level equal to or lower than a preset upper limit. Alternatively, the sound output controller 23 may control the sound output unit 13 to output the sound of an output target after subtracting predetermined decibels from a reference sound level.

In Step S110, the sound output controller 23 controls the sound output unit 13 to output the sound, without such sound level limitation described above, that is, at a preset reference sound level.

FIG. 4 is a flowchart illustrating, in detail, a process of determining the status of use, which is included in the process in FIG. 3, i.e., protection of the sense of hearing.

In Steps S201 to S220, pieces of flag information forming the state information 32 are generated based on values detected by the individual state sensors 12. The following details the generation. It is noted that the list: flag information generation based on a value detected by the GPS 41 (i.e., Steps S201 to S204); flag information generation based on a value detected by the Hall IC 42 (i.e., Steps S205 to S208); flag information generation based on a value detected by the illumination sensor 43 (i.e., Steps S209 to S212); flag information generation based on a value detected by the proximity sensor 44 (i.e., Steps S213 to S216); and flag information generation based on a value detected by the accelerometer 45 (i.e., Steps S217 to S220), may be executed in parallel or executed sequentially in any order.

In Step S201, the acquisition unit 21 acquires positional information from the GPS 41. The acquisition unit 21 may acquire the positional information at short time intervals while the status of use is being determined. For positional information that is usually acquired every several minutes, the acquisition unit 21 may acquire this information every several seconds.

In Step S202, the determination unit 22 determines whether the positional information acquired periodically changes every moment. For changes in the positional information (i.e., if YES), the determination unit 22 proceeds from Step S202 to Step S203. For no changes in the positional information (i.e., If NO), the determination unit 22 proceeds from Step S202 to Step S204.

The determination unit 22 determines in Step S203 that the smartphone 1, to be precise, a user carrying the smartphone 1, is moving, and sets a flag representing the presence of movement. To be specific, the determination unit 22 stores the value “1” representing the presence of movement, in the first item of the state information 32.

The determination unit 22 determines in Step S204 that the smartphone 1 is not moving, and sets no flag. To be specific, the determination unit 22 stores the value “0” representing the absence of movement, in the first item.

In Step S205, the acquisition unit 21 acquires a voltage value from the Hall IC 42. The voltage value may be acquired every several seconds for instance as described above.

The determination unit 22 determines in Step S206 whether the average of periodically acquired voltage values is higher or lower than a predetermined threshold. For a higher average value of voltage (i.e., if YES), the determination unit 22 proceeds from Step S206 to Step S207. For a lower average value of voltage (i.e., if NO), the determination unit 22 proceeds from Step S206 to Step S208.

The determination unit 22 determines in Step S207 that the cover of the smartphone 1 is closed, and sets a flag representing cover closure. To be specific, the determination unit 22 stores the value “1” representing cover closure, in the second item of the state information 32.

The determination unit 22 determines in Step S208 that the cover of the smartphone 1 is open (or the smartphone 1 has no cover), and sets no flag. To be specific, the determination unit 22 stores the value “0” representing cover opening, in the second item.

In Step S209, the acquisition unit 21 acquires an illumination value from the illumination sensor 43. The illumination may be acquired every several seconds for instance as described above.

The determination unit 22 determines in Step S210 whether the average of periodically acquired illumination values equals or exceeds a predetermined threshold, or the average falls below the predetermined threshold. For an illumination value equal to or greater than the predetermined threshold (i.e., if YES), the determination unit 22 proceeds from Step S210 to Step S211. For an illumination value less than the predetermined threshold (i.e., if NO), the determination unit 22 proceeds from Step S210 to Step S212.

The determination unit 22 determines in Step S211 that the surroundings of the smartphone 1 are bright, and sets a flag representing the state of being bright. To be specific, the determination unit 22 stores the value “1” representing the state of being bright, in the third item of the state information 32.

The determination unit 22 determines in Step S212 that the surroundings of the smartphone 1 are dark, and sets not flag. To be specific, the determination unit 22 stores the value “0” representing the state of being dark, in the third item.

In Step S213, the acquisition unit 21 acquires an ON/OFF signal from the proximity sensor 44. The ON/OFF signal may be acquired anytime during the power-on of the smartphone 1. Alternatively, the ON/OFF signal may be acquired at relatively short time intervals (e.g., every several milliseconds to several seconds), only while the status of use is being determined.

The determination unit 22 determines in Step S214 whether there is an ON-signal among periodically acquired signals. For the presence of an ON-signal (i.e., if YES), the determination unit 22 proceeds from Step S214 to Step S215. For the absence of an ON-signal (i.e., if NO), the determination unit 22 proceeds from Step S214 to Step S216.

The determination unit 22 determines in Step S215 that there is an object in proximity to or contact with the smartphone 1, and sets a flag representing the presence of an object. To be specific, the determination unit 22 stores the value “1” representing the presence of an object, in the fourth item of the state information 32.

The determination unit 22 determines in Step S216 that there is no object in proximity to or contact with the smartphone 1, and sets no flag. To be specific, the determination unit 22 stores the value “0” representing the absence of an object, in the fourth item.

In Step S217, the acquisition unit 21 acquires an acceleration value from the accelerometer 45. The acceleration value may be acquired every several seconds for instance as described above.

In Step S218, the determination unit 22 compares the periodically acquired acceleration values with a predetermined threshold to determine whether an acceleration value equal to or greater than the predetermined threshold has been measured. For a measured acceleration value equal to or greater than the predetermined threshold (i.e., if YES), the determination unit 22 proceeds from Step S218 to Step S219. For no measured acceleration value equal to or greater than the predetermined threshold (i.e., if NO), the determination unit 22 proceeds from Step S218 to Step S220.

The determination unit 22 determines in Step S219 that the smartphone 1 is in motion (to be precise, the user is operating the smartphone 1), and sets a flag representing motion. To be specific, the determination unit 22 stores the value “I” representing motion, in the fifth item of the state information 32.

The determination unit 22 determines in Step S220 that the smartphone 1 stays motionless, and sets no flag. To be specific, the determination unit 22 stores the value “0” representing the state of being motionless, in the fifth item. It its noted that the state of being motionless may herein include not only the state of being completely motionless, but also a state where the smartphone 1 is moving slightly or very slowly at acceleration less than a predetermined value.

In Step S221, the determination unit 22 stores, in the storage 11, the state information 32 consisting of the flag information pieces based on the individual state sensors 12 and generated in the foregoing individual process steps.

In Step S222, the determination unit 22 refers to the rule table 31, stored in the storage 11, to determine the current (i.e., at the time point of Step S101) status of use of the smartphone 1. To be specific, the determination unit 22 determines whether the user is listening to a sound, and determines whether the user, even when not listening to a sound, is holding the smartphone 1 near his/her head. For instance, the determination unit 22 refers to the rule table 31 to identify the status-of-use information 33 associated with the flag pattern of the state information 32 stored in Step S221.

In Step S223, the determination unit 22 stores, in the storage 11, the status-of-use information 33 identified in Step S222.

After Step S223, the determination unit 22 can proceed to Step S103 in FIG. 3, and determine whether sound level limitation is necessary on the basis of the status-of-use information 33 stored in Step S223.

The foregoing configuration and method enables the status of use of the smartphone 1 to be identified based on the values detected by the individual state sensors 12. The necessity or unnecessity of sound level limitation is then determined based on the identified status of use. To be specific, the determination unit 22 can determine that sound level limitation is necessary while the user is listening to a sound emitted from the smartphone 1. The determination unit 22 can also determine that sound level limitation is necessary while the user, even when not listening to a sound, is holding the smartphone 1 in such a way as to place the smartphone 1 near his/her head (or ear).

Through the foregoing process steps, the sound level of output sounds relating to an alarm, notification, and other things is limited while the user is listening to a sound emitted from the smartphone 1 or the user is holding and placing the smartphone 1 near his/her ear. Such sound level limitation consequently enables a communication apparatus (e.g., a smartphone) to protect the user's sense of hearing or the user's body and mind from a loud sound that can occur under various use conditions.

The controller 10 does not impose sound level limitation while the user is not listening to a sound and is not holding and placing the smartphone 1 near his/her ear. Such a configuration and method can solve the following problem.

Sound level limitation on an output sound in the endeavor of avoiding a risk that adversely affects the user's sense of hearing or the user's body and mind, can reduce the level of a sound to which the user actually wants to listen, or can cause the user who is away from the communication apparatus to miss the sound of an important alarm, such as an earthquake early warning. For instance, such a problem resulting from unnecessary sound level limitation tends to arise in an electronic apparatus that includes a receiver-cum-loudspeaker.

The technique in the present disclosure enables a communication apparatus (e.g., a smartphone) to protect, at proper timing as necessary, the user's sense of hearing or the user's body and mind from a loud sound that can occur under various use conditions. The technique is thus suitable for an electronic apparatus that includes a receiver-cum-loudspeaker.

Modifications

When the cover of the smartphone 1 is closed, it is preferable that the determination unit 22 not immediately determine that the smartphone 1 is not in use and needs no sound level limitation. The determination unit 22 may determine the attitude of the smartphone 1 on the basis of a detected value acquired from the accelerometer 45 and of a detected value acquired from a gyroscope (not shown). Upon determining that the smartphone 1 remains upright either vertically or horizontally even with its cover closed, the determination unit 22 may determine that sound level limitation is necessary on the basis of the possibility that the user is holding the smartphone 1 by hand and placing the smartphone 1 on his/her ear.

The acquisition unit 21 may monitor the connector 53 and supply, to the determination unit 22, a signal indicating whether the connector 53 is connected to an external sound output unit, such as earphones or a headset. The acquisition unit 21 may also monitor a near-field communication unit (not shown), e.g., a Bluetooth (registered trademark) communication unit, installed in the smartphone 1. The acquisition unit 21 may then supply a signal indicating whether communication with the external sound output unit has been established, to the determination unit 22 via the near-field communication unit. The determination unit 22 can consequently generate, as part of the state information 32, flag information indicating whether the external sound output unit is being connected.

When the external sound output unit is being connected, the determination unit 22 may determine that sound level limitation is necessary, regardless of other detected values from the state sensors 12. The sound output controller 23 can accordingly set a low, upper limit to the sound level of a notification sound, such as an emergency warning sound. When the external sound output unit is being connected, the user is highly probably listening to a sound emitted from the external sound output unit. The foregoing configuration enables the sound level of the output sound to fall within the upper limit while the external sound output unit is being connected, thus protecting the user's sense of hearing and the user's body and mind.

The acquisition unit 21 may monitor an audio conversation mechanism (not shown) installed in the smartphone 1, and may supply a signal indicating whether the line is busy to the determination unit 22. The determination unit 22 can consequently generate, as part of the state information 32, flag information indicating whether the line is busy.

When the audio conversation mechanism is keeping the line busy, the determination unit 22 may determine that sound level limitation is necessary, regardless of other detected values from the state sensors 12. The sound output controller 23 can accordingly impose, while the line is busy, sound level limitation on a sound other than a received sound from the receiver 52 (e.g., an output sound from the loudspeaker 51). The foregoing configuration can reduce the sound level of sounds emitted from the other sound output units 13 during a user's telephone conversation, thereby protecting the user's sense of hearing and the user's body and mind.

The determination unit 22 may determine the status of use every time an event accompanied by audio output occurs in the smartphone 1. The determination unit 22 may identify the status of use as of now on the basis of values detected by the individual state sensors 12 during a predetermined time period that comes before the current point of time, and may determine the necessity or unnecessity of sound level limitation every time an event occurs. The sound output controller 23 limits sound level as necessary, in accordance with a determination result sent from the determination unit 22, and outputs a sound resulting from an event.

Example Implementation by Software

The control blocks of the controller 10 (in particular, the acquisition unit 21, determination unit 22, and sound output controller 23) may be implemented by software or by a logic circuit (i.e., hardware) formed in, but not limited to, an integrated circuit (i.e., IC chip).

For software, the controller 10 includes a computer that executes commands of a program or software that implements each function. This computer includes, but not limited to, at least one processor (i.e., controller) and at least one computer-readable recording medium recording the program. The processor in the computer reads the program from the recording medium and executes the program, thus achieving the object of the present invention. The processor can be a central processing unit (CPU) for instance. The recording medium can be a non-transitory tangible medium, including a read only memory (ROM), tape, disk, card, semiconductor memory, and programmable logic circuit. This computer may further include, but not limited to, a random access memory (RAM) that develops the foregoing program. The program may be supplied to the computer via any transmission medium (e.g., a communication network and a broadcast wave) that can transmit the program. One aspect of the present invention can be implemented in the form of a data signal embodied by electronic transmission of the program and embedded in a carrier wave.

Summary

A first aspect of the present invention is directed to an electronic apparatus (i.e., smartphone 1) that includes at least one sound output unit 13, a plurality or sensors (i.e., state sensors 12), and at least one controller 10. The at least one controller 10 performs a process (i.e., Step S102) of determining the status of use of the electronic apparatus in accordance with detected values acquired from the individual sensors. The at least one controller 10 also performs a process (i.e., Step S109) of, upon determining that the electronic apparatus is under a status of use where an output sound emitted from the at least one sound output unit 13 needs to undergo sound level limitation, limiting the sound level of the output sound when an event accompanied by audio output occurs in the electronic apparatus.

The electronic apparatus according to a second aspect of the present invention is configured, in the first aspect, such that as the status of use where the output sound needs to undergo the sound level limitation, the at least one controller 10 determines at least one of a status of use where the electronic apparatus is being held while being adjacent to the head of a user, and a status of use where the user is listening to the output sound from the electronic apparatus.

A third aspect of the present invention is directed to a controller 10 that controls an electronic apparatus (i.e., smartphone 1) that includes at least one sound output unit 13 and a plurality of sensors (i.e., state sensors 12). The controller 10 includes a determination unit 22 that determines the status of use of the electronic apparatus in accordance with detected values acquired from the individual sensors. The controller 10 also includes a sound output controller 23 that, upon determination that the electronic apparatus is under a status of use where an output sound emitted from the at least one sound output unit 13 needs to undergo sound level limitation, limits the sound level of the output sound when an event accompanied by audio output occurs in the electronic apparatus.

A fourth aspect of the present invention is directed to a method for controlling an electronic apparatus (i.e., smartphone 1) that includes at least one sound output unit 13, a plurality of sensors (i.e., state sensors 12), and at least one controller 10. The method includes a step (i.e., Step S102) of determining the status of use of the electronic apparatus in accordance with detected values acquired from the individual sensors. Herein, the determining step is performed by the at least one controller 10. The method also includes a step (i.e., Step S109) of, upon determining that the electronic apparatus is under a status of use where an output sound emitted from the at least one sound output unit 13 needs to undergo sound level limitation (i.e., if YES in Step S107), limiting the sound level of the output sound when an event accompanied by audio output occurs in the electronic apparatus. Herein, the limiting step is performed by the at least one controller 10.

The controller 10 according to the foregoing aspects of the present invention may be implemented by a computer. In this case, the scope of the present invention includes, as well, a control program for implementing the controller 10 with a computer that operates as the individual units (software elements) of the controller 10. The scope of the present invention also includes a computer-readable recording medium storing the control program.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An electronic apparatus comprising:
at least one sound output unit;
a plurality of sensors; and
at least one controller,
wherein the at least one controller is configured to perform processes of,
determining a status of use of the electronic apparatus in accordance with detected values acquired from the plurality of individual sensors, and
upon determining that the electronic apparatus is under a status of use where an output sound emitted from the at least one sound output unit needs to undergo sound level limitation, limiting a sound level of the output sound when an event accompanied by audio output occurs in the electronic apparatus.

2. The electronic apparatus according to claim 1, wherein
as the status of use where the output sound needs to undergo the sound level limitation, the at least one controller determines at least one of a status of use where the electronic apparatus is being held while being adjacent to a head of a user, and a status of use where the user is listening to the output sound from the electronic apparatus.

3. A controller that controls an electronic apparatus that includes at least one sound output unit and a plurality of sensors, the controller comprising:
a determination unit configured to determine a status of use of the electronic apparatus in accordance with detected values acquired from the plurality of individual sensors; and
a sound output controller configured to, upon determination that the electronic apparatus is under a status of use where an output sound emitted from the at least one sound output unit needs to undergo sound level limitation, limit a sound level of the output sound when an event accompanied by audio output occurs in the electronic apparatus.

4. A method for controlling an electronic apparatus that includes at least one sound output unit, a plurality of sensors, and at least one controller, the method comprising:
determining a status of use of the electronic apparatus in accordance with detected values acquired from the plurality of individual sensors, the determining step being performed by the at least one controller, and
upon determining that the electronic apparatus is under a status of use where an output sound emitted from the at least one sound output unit needs to undergo sound level limitation, limiting a sound level of the output sound when an event accompanied by audio output occurs in the electronic apparatus, the limiting step being performed by the at least one controller.
